(19) United States
(12) Patent Application Publication
(10) Pub. No.: US 2003/0235322 A1
(43) Pub. Date: Dec. 25, 2003

(54) Hanging hook device of earphone

(75) Inventor: I-Chang Lu, KaoHsiung (TW)

Correspondence Address: BRUCE H. TROXELL, SUITE 1404, 5205 LEESBURG PIKE, FALLS CHURCH, VA, 22041, US

(73) Assignee: AIPTEK INTERNATIONAL INC.

(21) Appl. No.: 10/175,037

(22) Filed: Jun. 20, 2002

(51) Int. Cl. H04R 25/00

(52) U.S. Cl. 381/381; 381/330

(57) ABSTRACT

The invention is to provide a hanging hook device of earphone, abutted against one side of the external ear of human body and has a pivoting-and-fixing part, arranged with a plurality of fixation seats that respectively have a penetration hole, through which a pivoting axis is passed, such that two ends of the pivoting axis are extended out the fixation seat respectively. The hanging hook device of earphone is comprised of a hanging hook of arm and a pivoting part. The hanging hook of arm be provided for being hanged at the outer edge of the external ear of human body, while the pivoting part is connected to one end of the hanging hook of arm for providing a connection to the pivoting-and-fixing part, which is at least arranged with two pivoting seats, a plurality of trough ditches, and at least one positioning part. The pivoting seats are respectively arranged at the two sides of the pivoting part and there is an opening hole in each interior of pivoting seats for providing one end of the pivoting axis to be placed into and connected with. The trough ditch is arranged corresponding to the fixation seat and, in the meantime, the positioning part is arranged between two adjacent trough ditches. However, two sides of the positioning part corresponding to the pivoting axis respectively having an opening trough, provided for a connection and fixation to the pivoting axis.

### FIELD OF THE INVENTION

The invention relates to a hanging hook device of earphone, particularly to a kind of hanging hook device of earphone that may be hanged at the external ear of human body.

### BACKGROUND OF THE INVENTION

Since technology is changed with each passing day, so communication between people is become more frequent and their interaction is also become more intimate. On the emphasis of high living standard of today, recreation activity no doubt becomes indispensable for everybody. The development of technology has made electronic products penetrate into each family and various walks of life. Especially, the electronic facilities of image and video have further become the necessity of recreation activities in modern living. Following the prevalence of electronic products, it is further needed more accessory products to be interconnected as the functions of input, output and usage. Therefore, the earphone device is dignified as one of the best devices of output among the electronic products of image and video of today.

The casing of the earphone according to the prior arts is covered with an amplifier, which is placed between the contour of the external ear and the projection of human body, such that the ear cavity may receive the sound signal of the amplifier but, after the long term of usage of the earphone according to the prior arts, not only will the ear be uncomfortable, but also will the tinnitus and the weakness of hearing be incurred. Therefore, the relative businessmen develop an earphone of head-hanging type, which can be hanged at the external ear of human body and be kept an appropriate distance with the interior of ear cavity. Therefore, the sound signal of the amplifier is received by the contour of the ear first and is transferred into the interior of the ear cavity then, so it would not be incurred the uncomfortable tinnitus and the weakness of hearing because of the long term of reception of the sound signal of the amplifier. But, since the assembly of the earphone of head-hanging type according to the prior arts is complicated and uneasy, so it is frequently incurred damages and breaks during assembly process, such that the labor time and the cost of manufacture are increased. This is a problem needed to solve urgently by the relative business to thereby lower down the disbursement of cost and enhance the competition ability of business. The solution and breakthrough of such problem are really demanded without any further delay.

### SUMMARY OF THE INVENTION

The main object of the invention is to provide a hanging hook device of earphone, designed with a connection mechanism between a pivoting part and a pivoting-and-fixing part of the earphone to provide a hanging hook of arm that is facilitated to be separated from and assembled with the earphone main body, so that it can achieve the further enhancement of the functions exiting in original earphone, the reduction of complexity of the assembly, and the function of lowering down the labor time and the cost of production.

To achieve above object, the hanging hook device of earphone of the invention, wherein one side of the earphone abutting against the external ear of human body has a pivoting-and-fixing part, arranged with a plurality of fixation seats that respectively have a penetration hole, through which a pivoting axis is passed, such that two sides of the pivoting axis are respectively extended out the fixation seat and, the hanging hook device of earphone of the invention is comprised of a hanging hook of arm and a pivoting part.

The hanging hook of arm is structured as a multiple-arc shape and can be provided for being hanged at the outer edge of the external ear of human body.

The pivoting part, connected to one end of the hanging hook of arm, can be provided for a connection to the pivoting-and-fixing part, and the pivoting part is at least arranged with two pivoting seats, a plurality of trough ditches, and at least one positioning part. The pivoting seats are respectively arranged at the two sides of the pivoting part, and the interior of the pivoting seat has an opening hole, provided for one end of the pivoting axis to be placed into and connected with. The trough ditch is arranged corresponding to the fixation seat, while the positioning part is arranged between two adjacent trough ditches, wherein two sides of the positioning part corresponding to the pivoting axis respectively having an opening trough, provided for a connection and fixation to the pivoting axis.

For your esteemed members of reviewing committee to further understand and recognize the merits of the present invention, a detailed description matching with corresponding drawings are presented as follows.

### BRIEF DESCRIPTION OF THE DRAWINGS

FIG. 1 is an explosive illustration for the three-dimensional structure of a preferable embodiment of the matching-up of assembly between an earphone and the hanging hook device of earphone of the invention.

FIG. 2 is an illustration for the three-dimensional structure of a preferable embodiment of the hanging hook device of earphone of the invention.

FIG. 3 is an assembly illustration for the three-dimensional structure of a preferable embodiment of the hanging hook device of earphone of the invention.

### DETAILED DESCRIPTION OF THE INVENTION

The main technical spirit of the invention is to provide an arrangement in one pivoting part, which is connected with the pivoting-and-fixing part, while two sides of the pivoting part is arranged with a pivoting seat capable of making deformation motion of elasticity in appropriate angle, by which the pivoting axis and the pivoting seat may be connected with and separated from each other, such that the shortcomings of impossibility of interchange and the difficulty of assembly according to the prior arts can be overcome.

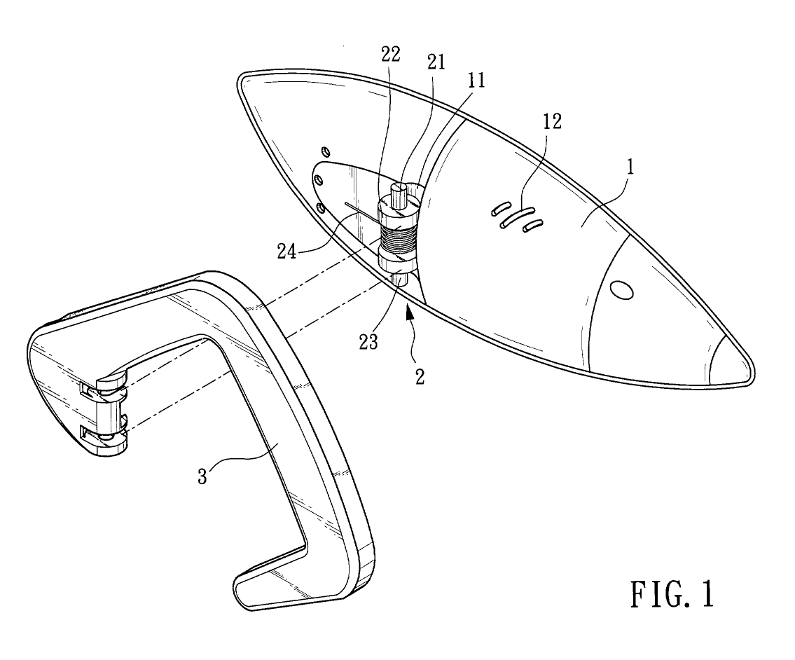

Please refer to FIG. 1, which is an explosive illustration for the three-dimensional structure of a preferable embodiment of the matching-up of assembly between an earphone and the hanging hook device of earphone of the invention. The earphone 1 is structured as a shape of water drop and may be abutted against one external ear of human body (not shown in the figure). By arranging an amplifier 12 corresponding to the external ear, a sound signal may be provided. The abutting side of the earphone 1 has at least one groove 11 shaped as an arc, with which a pivoting-and-fixing part 2 is connected. The pivoting-and-fixing part 2 is at least arranged with a plurality of fixation seats 22, a pivoting axis 23, and at least one elastic element 24. The fixation seat 22 is connected integrally with the groove 11 as one body, while there is one penetration hole 21 that is arranged at an appropriate position of the center of fixation seat 22 and is made as a circular shape. The pivoting axis 23 first passes through the penetration hole 21, then penetrates into the elastic element 24, and again passes through another penetration hole 21, such that two sides of the pivoting axis 23 are respectively protruded out the fixation seat 22 for facilitating a connection to a hanging hook device of earphone 3, so a earphone device available for being carried along and being hanged at the external ear of human body is created. In the preferable embodiment of the invention, the number of the fixation seat 22 is two and, of course, it may also be three or more. The pivoting axis 23 matched with the penetration hole 21 is structured as a cylinder shape. The number of the elastic element 24 is at least one, and it is arranged between two adjacent fixation seats 22. If, when the number of the fixation seat 22 is three, then the number of the elastic element 24 is two. Such kind of variation of number is not described repetitiously herein any more, because above embodiment is belonged to the prior arts and is not the technical characteristic of the invention and, therefore, a detailed description is not presented hereinafter.

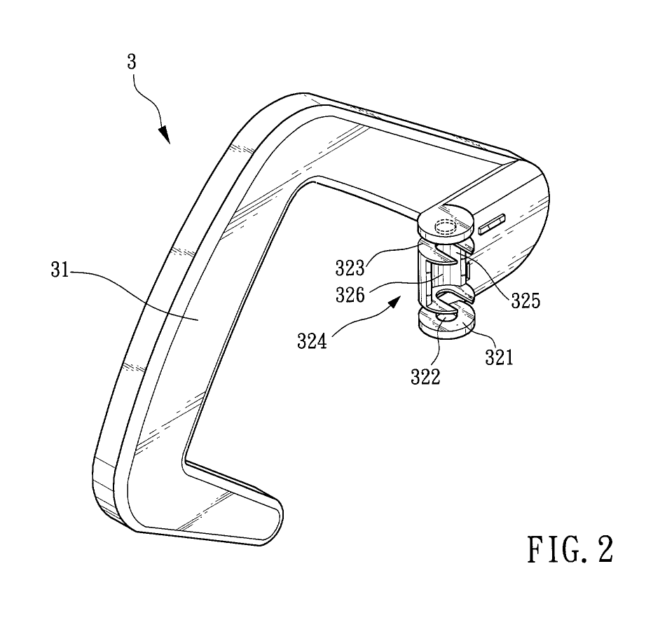

Please refer to FIG. 2, which is an illustration of the three-dimensional structure of a preferable embodiment of the hanging hook of earphone of the invention. The hanging hook device of earphone 3 of the invention is comprised of a hanging hook of arm 31 and a pivoting part. The hanging hook of arm 31 may be provided for being hanged at the outer edge of human body, and the abutting side of the hanging hook of arm 31 at the external ear is designed as a structure of multiple-arc shape and is suitable for the ergonomics to be able to be hanged comfortably at the outer ear. In the meantime, the pivoting part 32 is connected to one end of the hanging hook of arm 31.

Moreover, the pivoting part 32 may be provided for a connection to the pivoting-and fixing part 2, and is at least arranged with two pivoting seats 321, a plurality of trough ditches 323, and at least one positioning part 324. In the preferable embodiment of the invention, the pivoting seats 321 are respectively arranged at two sides of the pivoting part 32, and the material of the pivoting seat 321 is plastic or other composite material comprising an elastic device, so it can make a deformation motion of elasticity in appropriate angle. At an appropriate position in the interior of the pivoting seat 321, there is arranged with an opening hole 322, which may be provided for one end of the pivoting axis 23 to be placed into and connected with. In the preferable embodiment of the invention, the pivoting seat 321 has an appropriate thickness, and the opening hole 322 is kept an appropriate distance with one end of the pivoting seat 321. Of course, when the thickness of the pivoting seat 321 is thinner, the opening hole 322 may be also designed as a hole penetrating through the pivoting seat 321. This kind of design will not influence the deformation motion of elasticity of the pivoting seat 321. Such kind of variation of design can be implemented by those who are familiar with such kind of arts according to above disclosure, but it still possesses the merits of the invention, and it is also within the spirit and scope of the invention, so a detailed description is not presented repetitiously herein any further. The number and the position of the trough ditch 323 are arranged corresponding to the fixation seat 22 for facilitating the fixation seat 22 to be inset into and connected with the trough ditch 323. The positioning part 324 is arranged between two adjacent trough ditches 323, wherein two sides of the positioning part 324 corresponding to the pivoting axis 23 respectively having an opening trough 325, which may be provided for a connection and fixation to the pivoting axis 23. Further, by arranging an accommodation trough 326 between two opening troughs 325, it may be provided for the elastic element 24 to be placed in.

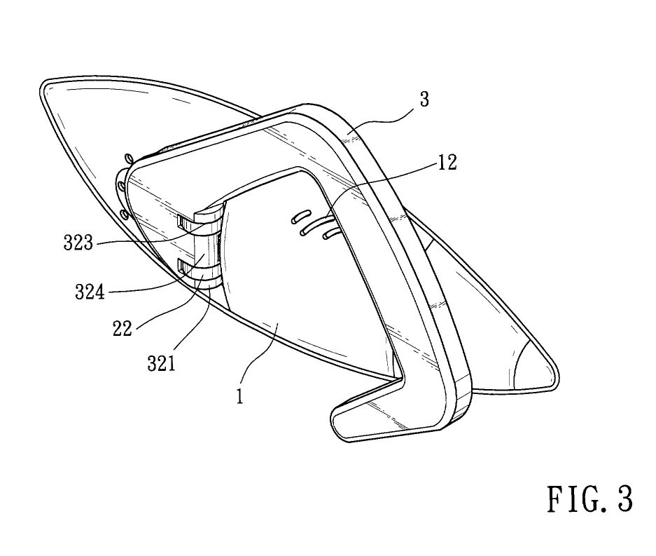

When the hanging hook device of earphone 3 is assembled with the earphone 1, an appropriate force is applied on the hanging hook device of earphone 3 so that, by making a deformation motion of elasticity to the pivoting seat 321 with appropriate angle, it may make two sides of the pivoting axis 23 insets into the opening hole 322 respectively. Since these devices of pivoting seats 321 are operated within their deformation zones of elasticity and the plastic deformation is not reached, so they will not be damaged or generated any permanent deformation and can be used repetitiously. The fixation seat 22 is also inset into and connected with the trough ditch 323. By applying the opening trough 325 to be provided for a connection and fixation to the pivoting axis 23, it may create an assembly state of a three-dimensional structure of a preferable embodiment between the earphone and the hanging hook device of earphone of the invention as shown in FIG. 3 and, an earphone device available for being carried along and being hanged at the external ear of human body for application has been formed. In sum, the hanging hook device of earphone according to the present invention may indeed reach the functions exiting in original earphone, further reduces the complexity of assembly, and lowers down the labor time and cost of production. The shortcomings of the prior arts are really overcome, the requests of the industrial production are fulfilled, and their abilities of manufacturing competition are also enhanced.

What is claimed is:

1. A hanging hook device of earphone, one side of the earphone abutting against the external ear of human body has a pivoting-and-fixing part, arranged with a plurality of fixation seats that respectively have a penetration hole, through which a pivoting axis is passed, such that two sides of the pivoting axis are respectively extended out the fixation seat, comprising:
a hanging hook of arm, structured as a multiple-arc shape and can be provided for being hanged at the outer edge of the external ear of human body; and
a pivoting part, connected to one end of the hanging hook of arm and can be provided for a connection to the pivoting-and-fixing part, comprising:
two pivoting seats, which are respectively arranged at the two sides of the pivoting part, and the interior of the pivoting seat has an opening hole, which be provided for one end of the pivoting axis to be placed into and connected with;
a plurality of trough ditches, arranged corresponding to the fixation seats;
at least one positioning part, arranged between two adjacent trough ditches, wherein two sides of the positioning part corresponding to the pivoting axis respectively having an opening trough which is provided for a connection and fixation to the pivoting axis.

2. The hanging hook device of earphone according to claim 1, wherein the material of the pivoting seat is plastic or other composite material comprising an elastic element.

3. The hanging hook device of earphone according to claim 1, wherein the pivoting seat makes a deformation motion of elasticity in appropriate angle.

4. The hanging hook device of earphone according to claim 1, wherein the opening hole penetrates through the pivoting seat.

5. The hanging hook device of earphone according to claim 1, wherein the opening hole is kept an appropriate distance with one end of the pivoting seat.

6. The hanging hook device of earphone according to claim 1, wherein the positioning part has an accommodation trough, arranged between two adjacent opening troughs and can be provided for placing an elastic element.

7. The hanging hook device of earphone according to claim 6, wherein the elastic element is arranged between two adjacent fixation seats.
